(19) United States
(12) Patent Application Publication
(10) Pub. No.: US 2022/0341899 A1
(43) Pub. Date: Oct. 27, 2022

(54) ANALYZER AND ANALYSIS SYSTEM

(71) Applicant: Shimadzu Corporation, Kyoto (JP)

(72) Inventor: Ken MATAMA, Kyoto (JP)

(21) Appl. No.: 17/237,736

(22) Filed: Apr. 22, 2021

(51) Int. Cl. G01N 30/86; G08B 5/22; G06F 16/18

(52) U.S. Cl. CPC G01N 30/8665; G08B 5/22; G01N 30/8696; G06F 16/1805; G01N 2030/027

(57) ABSTRACT

An analyzer is provided with a device body for analyzing a sample and an information processing apparatus for controlling the operation of the device body. The information processing apparatus is configured to collect an operation log indicating an internal operation of the device body. In the operation log, information indicating an operation command issued by the information processing apparatus and information indicating an operation content performed by the device body in response to the operation command are associated on a one-to-one basis.

### CROSS-REFERENCE TO RELATED APPLICATIONS

This application claims priority under 35 U.S.C. § 119 to Japanese Patent Application No. 2018-195044 filed on Oct. 16, 2018, the entire disclosure of which is incorporated herein by reference in its entirety.

### BACKGROUND OF THE INVENTION

### Field of the Invention

The present disclosure relates to an analyzer and an analysis system.

### Description of the Background Art

An analysis system for managing and processing various data obtained by an analyzer is described in WO2017/098599. In the analysis system described in WO2017/098599, the measurement data obtained in the analyzer and the processing result data obtained by analyzing the measurement data are registered in a database constructed on a server connected to the analyzer. Further, in the analysis system, information about various operations related to the user's logging-in/out operation to the analyzer or a file is also registered in a database as operation log information. The operation log information includes contents of operations performed by a user, the date and time when the operation was performed, the ID for identifying the device on which the operation was performed, and the ID for identifying the person who performed the operation.

### SUMMARY OF THE INVENTION

According to the analysis system described in WO2017/098599, for example, when submitting a test result based on the data file stored in a database, an audit trail can be generated by extracting the operation log information related to this data file from the database.

However, in case where an abnormality has occurred in the analyzer during the analysis, it is not possible to know the internal state of the analyzer at the time of the occurrence of the abnormality by referring to the data file and/or the operation log information stored in the database. Therefore, there is a concern that a great amount of labor is required for the abnormality analysis.

The present disclosure has been made to solve such problems. An object of the present disclosure is to improve the convenience of a user for managing and processing data in an analysis system for managing and processing data collected in an analyzer.

According to one aspect of the present disclosure, an analyzer is provided with a device body configured to analyze a sample and an information processing apparatus configured to control an operation of the device body. The information processing apparatus is configured to collect an operation log indicating an internal operation of the device body. In the operation log, information indicating an operation command issued by the information processing apparatus and information indicating an operation content executed by the device body in response to the operation command are associated on a one-to-one basis.

According to the above-described analyzer, by collecting the operation log indicating the internal operation of the device body, it is possible to know the internal state of the analyzer based on the collected operation log. With this, for example, it is possible to grasp the internal state of the analyzer when an abnormality has occurred, so that it is possible to efficiently perform the abnormality analysis. Also, in the operation log, the information indicating the operation command and the information indicating the operation content in response to the operation command are associated on a one-to-one basis. Therefore, the person in charge of the abnormality analysis can easily compare the operation command with the actual operation content. Thus, it becomes easy to detect the erroneous operation contrary to the operation command. As a result, the convenience of the user that manages and processes data can be improved.

In the above-described analyzer, preferably, in the operation log, the information indicating the operation command is given by a tag indicating that the information relates to the operation command, and the information indicating the operation content is given by a tag indicating that the information relates to the operation content.

With this, it is possible to easily distinguish between the information indicating the operation command and the information indicating the operation content. Thus, the convenience of the user can be improved.

In the above-described analyzer, preferably, the operation log further includes information indicating an object of an operation of the device body. With this, the user can easily recognize that the operation command and the operation content indicate which phase of the operation.

In the above-described analyzer, preferably, the operation log further includes information indicating a result derived by the information processing apparatus based on the operation of the device body. With this, the user can easily recognize the operation content in response to the operation command and the result based on this operation content.

According to another aspect of the present disclosure, an analysis system is provided with the above-described analyzer and a server communicatively coupled with the analyzer. The analyzer is configured to transmit the collected operation log to the server. The server includes a storage unit for storing the operation log.

According to the above-described analysis system, in the server, the internal state of the analyzer can be grasped based on the operation log stored in the storage unit. Thus, it is possible to efficiently analyze the operation of the analyzer.

In the above-described analysis system, preferably, the analyzer is configured to transmit the operation log when an abnormality of the analyzer is detected to the server. With this, an abnormality analysis of the analyzer can be performed efficiently using the operation log stored in the storage unit.

In the above-described analysis system, preferably, the analyzer is configured to periodically transmit the operation log to the server. The presence or absence of an abnormality sign of the analyzer is diagnosed using the operation log stored in the storage unit. With this, an abnormality sign of the analyzer can be detected by using the operation log stored in the storage unit.

In the above-described analysis system, preferably, the analyzer is configured to periodically transmit the operation log to the server. Calibration to ensure analysis accuracy of the analyzer is performed using the operation log stored in the storage unit. With this, it is possible to appropriately perform the calibration of the analyzer by using the operation log stored in the storage unit.

The above-described objects and other objects, features, aspects, and advantages of the present disclosure will become apparent from the following detailed descriptions of the invention that can be understood with reference to the attached drawings.

### BRIEF DESCRIPTION OF THE DRAWINGS

FIG. 1 is a schematic diagram showing a configuration example of an analysis system in accordance with this embodiment.

FIG. 2 is a schematic diagram showing a configuration example of the analyzer shown in FIG. 1.

FIG. 3 is a diagram schematically showing a configuration of an information processing apparatus.

FIG. 4 is a diagram schematically showing a configuration of a server.

FIG. 5 is a flowchart for explaining the processing procedures when executing an automatic voltage adjustment.

FIG. 6 is a diagram showing an example of a voltage adjustment execution setting screen.

FIG. 7 shows an example of an optimization result screen.

FIG. 8 shows an example of an optimization result screen.

FIG. 9 shows a configuration example of a database.

FIG. 10 shows a first configuration example of an operation log.

FIG. 11 shows a second configuration example of an operation log.

FIG. 12 shows a third configuration example of an operation log.

FIG. 13 is a flowchart for explaining processing procedures for performing an automatic voltage adjustment and an abnormality sign diagnosis.

FIG. 14 is a diagram showing an actual measurement result of the relation between the high-frequency voltage value and the signal intensity.

FIG. 15 is a diagram showing the relation between the mass-to-charge ratio and the high-frequency voltage value based on the actual measurement of FIG. 14.

FIG. 16 is a flowchart for explaining the processing procedures when performing an automatic voltage adjustment and an analyzer calibration.

### DESCRIPTION OF THE PREFERRED EMBODIMENT

Hereinafter, some embodiments of the present disclosure will be described with reference to the accompanying drawings. Note that in the following descriptions, the same or corresponding portion in the drawing will be allotted by the same reference numeral, and the explanation thereof will not be repeated basically.

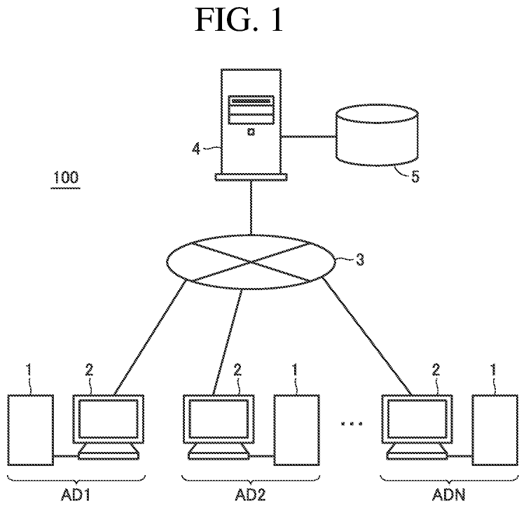

FIG. 1 is a schematic diagram for explaining a configuration example of an analysis system according to this embodiment;

Referring to FIG. 1, an analysis system 100 according to this embodiment is a system for analyzing a sample, and the system includes N (N is an integer) analyzers AD1 to ADN, a server 4, and a database 5.

Each of the analyzers AD1 to ADN is a device for analyzing a sample. In the following description, the analyzers AD1 to ADN are collectively referred to as analyzers AD. In this embodiment, as the analyzer AD, a liquid chromatograph mass spectrometer (LC/MS) is exemplified.

The analyzer AD has a device body 1 and an information processing apparatus 2. The device body 1 measures a sample. The information processing apparatus 2 controls the measurement in the device body 1 and performs a quantitative analysis of the measurement data by the device body 1. The information processing apparatus 2 is connected to the Internet 3, which is a typical communication network. With this, the respective information processing apparatuses 2 of the analyzers AD1 to ADN are mutually communicatively connected via the Internet 3.

Further, in the analysis system 100, the server 4 is connected to the Internet 3. Therefore, the information processing apparatus 2 of the analyzer AD can transmit and receive data to and from the server 4 bidirectionally via the Internet 3.

The server 4 is a server for mainly managing the N analyzers AD for which the analysis system 100 is operated. The server 4 collects and manages the information on N analyzers AD by communicating with N analyzers AD. The server 4 is, for example, a cloud server installed in a management center that manages the analysis system 100.

The database 5 is connected to the server 4. The database 5 is a storage unit for storing data exchanged between the server 4 and the analyzers AD. In FIG. 1, the server is configured by a memory and the database 5 externally connected to the server. However, the server 4 may be configured to have an internal storage unit. Note that the database 5 corresponds to one example of the “storage unit”.

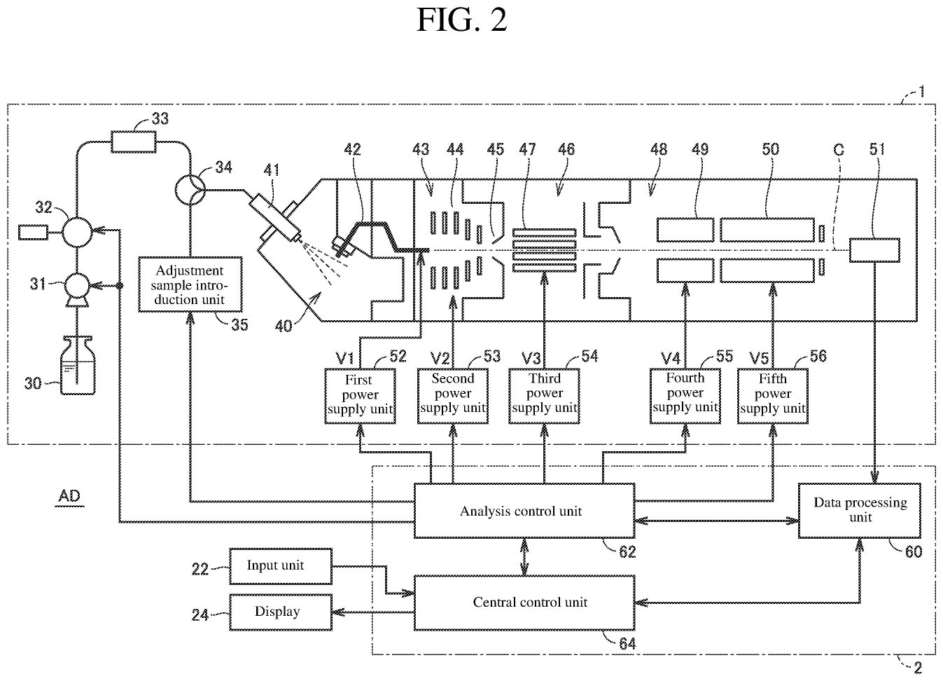

FIG. 2 is a diagram schematically showing a configuration example of the analyzer AD shown in FIG. 1.

Referring to FIG. 2, the analyzer AD is a liquid chromatograph mass spectrometer (LC/MS). The device body 1 is provided with a liquid chromatograph (LC) unit and a mass spectrometry (MS) unit.

The LC unit includes a mobile phase container 30, a liquid feeding pump 31, an injector 32, a column 33, a valve 34, and an adjustment sample introduction portion 35. The liquid feeding pump 31 sucks a mobile phase stored in the mobile phase container 30 and feeds it to the column 33 through an injector 32 at a constant flow rate. When a sample is injected by the injector 32, the sample is introduced into the column 33 with the flow of the mobile phase. While passing through the column 33, various components in the sample are separated and eluted from the outlet of the column 33 with a time lag. At the outlet of the column 33, a flow channel switching valve 34 is provided. During the normal analysis, the eluent from the column 33 is introduced into the MS unit via the valve 34.

On the other side of the valve 34, an adjustment sample introduction portion 35 is connected. When performing the automatic adjustment (automatic-tuning) to be described later, the valve 34 is switched so that the sample liquid from the adjustment sample introduction portion 35 is introduced to the MS unit. However, the introduction method of the adjustment sample is not limited thereto. For example, an adjustment sample may be injected into a mobile phase by the injector 32 to separate the components by the column 33. Further, it may be configured to provide a bypass flow path through which a mobile phase into which an adjustment sample has been injected at the injector 32 bypasses the column 33 and the mobile phase passing through the bypass flow path is introduced into the MS unit.

The MS unit has a configuration of a multi-stage differential exhaust system in which two chambers of a first intermediate vacuum chamber 43 and a second intermediate vacuum chamber 46 are provided between an ionization chamber 40 in a substantially atmospheric pressure atmosphere and an analysis chamber 48 in a high vacuum atmosphere to be evacuated by a high-performance vacuum pump (not shown). The ionization chamber 40 and the first intermediate vacuum chamber 43 are communicated with each other via a dissolvent tube 42 having a small diameter, and the first intermediate vacuum chamber 43 and the second intermediate vacuum chamber 46 are communicated with each other via a passage (orifice) having a very small diameter provided at the tip of the skimmer 45.

In the MS unit, an eluent containing a sample component is sprayed into the ionization chamber 40 in a substantially atmospheric pressure atmosphere while being charged in the electrospray unit 41, whereby the sample component is ionized. Note that the ionization may be performed using other atmospheric pressure ionization methods, such as, e.g., an atmospheric pressure chemical ionization method, rather than an electrospray ionization method. Ions generated in the ionization chamber 40 and microstructure droplets still not completely vaporized are drawn into the dissolvent tube 42 by the differential pressure, and further vaporization of the solvent from the fine droplets proceeds while passing through the heated dissolvent tube 42 to generate ions.

In the first intermediate vacuum chamber 43, a first ion guide 44 in which four electrode plates surrounding the ion optical axis C in a plane perpendicular to the ion optical axis C are arranged plural in the ion optical axis C direction. The ions are focused by the first ion guide 44 to pass through the orifice and enters the second intermediate vacuum chamber 46. A second ion guide 47 consisting of eight rod electrodes arranged to surround the ion optical axis C is provided in the second intermediate vacuum chamber 46, so that ions are focused by the second ion guide 47 to be fed to the analysis chamber 48. In the analysis chamber 48, a quadrupole mass filter 50 consisting of four rod electrodes and a pre-rod electrode 49 consisting of four short rod electrodes arranged in the ion optical axis C direction in the preceding stage is provided. Only those ions having a particular mass-to-charge ratio among the various ions pass through the quadrupole mass filter 50 to reach the ion detector 51.

The information processing apparatus 2 is mainly composed of a CPU (Central Processing Unit), which is an arithmetic processing unit. The information processing apparatus 2 may be, for example, a personal computer. The information processing apparatus 2 includes a data processing unit 60, an analysis control unit 62, and a central control unit 64. The detection signal from the ion detector 51 is inputted to the data processing unit 60, and various data processing, such as, e.g., generation of a mass spectrum, a mask chromatogram, and a total ion chromatogram, is performed. The analysis control unit 62 controls the operations of the respective units of the LC unit 1A and the MS unit 1B including the power supply units 52 to 56, which will be described later, in order to perform the LC/MS analysis based on the instruction from the central control unit 64. Connected to the central control unit 64 are an input unit 22 and a display 24 as user interfaces. The central control unit 64 outputs various commands for analyses to the analysis control unit 62 or the data processing unit 60 in receipt of the operator's manipulation by the input unit 22. Further, the central control unit 64 outputs an analysis result, such as, e.g., a mass spectrum, to the display 24. Note that in the information processing apparatus 2, most of the central control unit 64, the analysis control unit 62, and the data processing unit 60 can be embodied by a personal computer with a predetermined control/processing software.

To each rod electrode of the quadrupole mass filter 50, a voltage V5 is applied from a fifth power supply unit 56. The voltage V5 is a voltage in which a predetermined DC bias voltage is added a voltage obtained by superimposing a high-frequency voltage and a DC voltage a voltage V5. In accordance with the high-frequency voltage and the DC voltage, a mass-to-charge ratio capable of passing through is determined.

To the dissolvent tube 42, a predetermined DC biasing voltage V1 is applied from a first power supply unit 52. To the first ion guide 44, a voltage V2 obtained by adding a DC bias voltage to a predetermined high-frequency voltage is applied from a second power supply unit 53. To the second ion guide 47, a voltage V3 obtained by adding a DC bias voltage to a predetermined high-frequency voltage is applied from a third power supply unit 54. Further, to the pre-rod electrode 49, a voltage V4 is applied from the fourth power supply unit 55. The voltage V4 is a voltage obtained by adding a predetermined DC vias voltage to a voltage obtained by superimposing a high-frequency voltage and a DC voltage. Note that in practice, a DC bias voltage is also applied to the skimmer 45, etc., other than the above, but here only typical one is described in order to avoid the complication of the description.

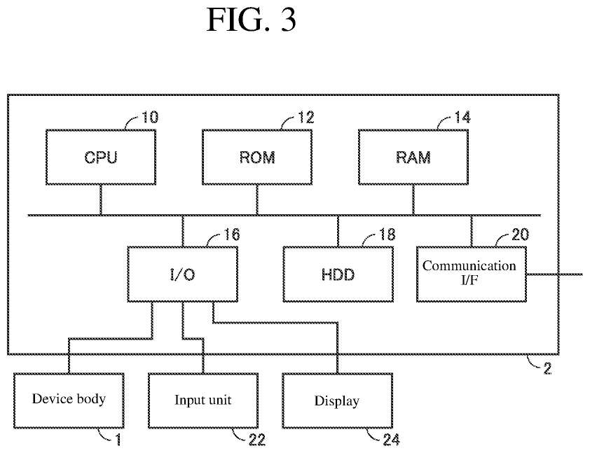

FIG. 3 is a diagram schematically showing configuration of the information processing apparatus 2.

Referring to FIG. 3, the information processing apparatus 2 includes a CPU10 for controlling the entire apparatus and a storage unit for storing programs and data, and is configured to operate in accordance with programs. The storage unit includes a ROM (Read Only Memory) 12, a RAM (Random Access Memory) 14, and an HDD (Hard Disk Drive) 18.

The ROM 12 can store a program to be executed by the CPU 10. The RAM 14 can temporarily store data to be used during the execution of the program by the CPU 10 and can act as a temporary data memory to be used as a workspace. The HDD 18 is a non-volatile storage device that can store measured data by the device body 1 and information generated by the information processing apparatus 2, such as, e.g., an analysis result by the information processing apparatus 2. In addition to or in place of the HDD 18, a solid-state memory device, such as, e.g., a flash memory, may be employed.

The information processing apparatus 2 further includes a communication interface 20, an I/O (Input/Output) interface 16, an input unit 22, and a display 24. The communication interface 20 is an interface for the information processing apparatus 2 to communicate with peripherals including the device body 1 and the server 4.

The I/O interface 16 is an interface for an input to the information processing apparatus 2 or an output from the information processing apparatus 2. As shown in FIG. 3, the I/O interface 16 is connected to the input unit 22 and the display 24.

The input unit 22 receives an input including an instruction to the information processing apparatus 2 from a measurer. The input unit 22 includes a keyboard, a mouse, a touch panel integrally configured with a display screen of the display 24, and the like, and receives a sample measurement condition and the like.

When setting the measurement conditions, the display 24 can display, for example, an input screen for measurement conditions, measurement data by the device body 1, and the like.

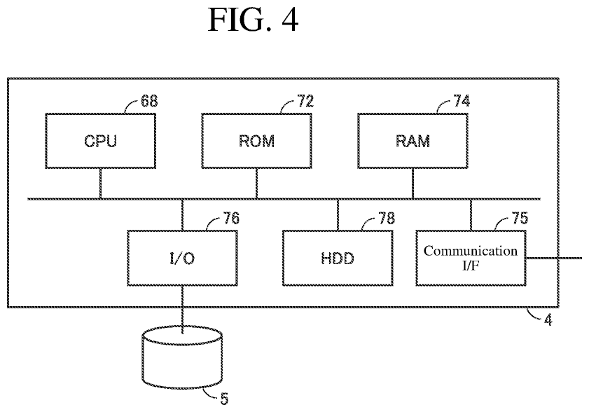

FIG. 4 is a diagram schematically showing the configuration of the server 4.

Referring to FIG. 4, the server 4 includes a CPU 68 for controlling the entire apparatus and a storage unit for storing programs and data and is configured to operate in accordance with the program. The storage unit includes a ROM 72, a RAM 74, an HDD 78, and a database 5.

The ROM 72 can store a program to be executed by the CPU 68. The RAM 74 can temporarily store data to be used during the execution of the program in the CPU 68, and can function as a temporary data memory used as a workspace. The HDD 78 and the database 5 are non-volatile storage devices and can store the information transmitted from the information processing apparatus 2.

The information processing apparatus 2 further includes a communication interface 75 and an I/O interface 76. The communication interface 75 is an interface for the server 4 to communicate with external equipment including the information processing apparatus 2.

The I/O interface 76 is an interface for an input to the server 4 or an output from the server 4. The I/O interface 76 is connected to the database 5. The database 5 is a memory for storing data transmitted and received between the server 4 and the information processing apparatus 2.

The server 4 may be configured to have a function equivalent to a conventional computer. The server 4 may further include a display unit and input unit.

### <Automatic Adjustment Function>

Referring back to FIG. 2, in the liquid chromatograph mass spectrometer, which is an analyzer AD, there are many parameters for calibrating the mass-to-charge ratio and adjusting the mass-resolution and the analytical sensitivity. The parameters include an applied voltage to each of an ionization interface, an ion guide, a quadrupole mass filter 50, an ion trap, and the ion detector 51.

In the calibration of the mass-to-charge ratio and the device adjustment, in general, various parameters are adjusted to optimal values so that the peak appearing in the spectrum comes to the proper position and the peak intensity becomes as high as possible and that the half-width becomes as narrow as possible while acquiring a mass spectrum by performing mass spectrometry of a standard sample of a known composition and concentration. In recent years, the device is often equipped with an automatic adjustment function (auto-tuning) that automatically adjusts various parameters. For example, by executing automatic adjustments at a frequency of about once a month, it is possible to keep the mass resolution and the analytical sensitivity at a high level at all times.

Here, in the liquid chromatograph mass spectrometer, in order to realize high mass resolution and analytical sensitivity, it is necessary that an ion which is an analysis target is introduced into the quadrupole mass filter 50 as efficiently as possible among ions generated in the ionization chamber 40 (or the dissolvent tube 42, the first intermediate vacuum chamber 43). For that purpose, it is necessary to maximize the ion passing efficiency in each ion transport optical element described above, respectively.

As an example, focusing on the transport efficiency of ions entering from the ionization chamber 40 to the second intermediate vacuum chamber 46, in order to increase as much as possible the transport efficiency of ions, it becomes important to appropriately set the DC bias voltage V1 applied from the first power supply unit 52 to the dissolvent tube 42 and the DC bias voltage V2 applied from the second power supply unit 53 to the second ion guide 47 in accordance with the mass-to-charge ratio of the ions passing through. Therefore, as a part of the automatic adjustment function, the automatic voltage adjustment for automatically adjusting the applied voltage to each location is executed. However, the operation of the analyzer AD when executing the automatic voltage adjustment will be described below.

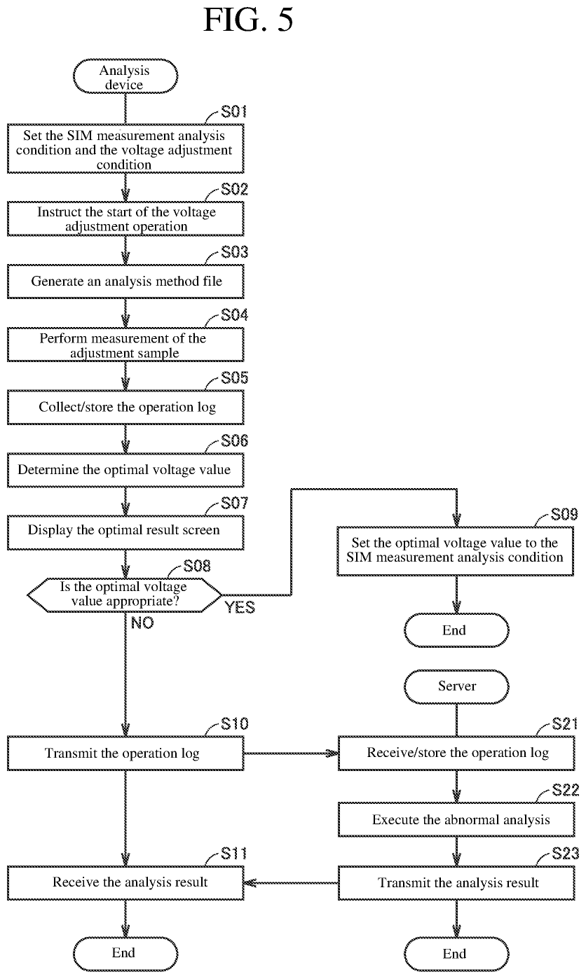

FIG. 5 is a flowchart for explaining processing procedures when executing the automatic voltage adjustment.

Referring to FIG. 5, first, in Step S01, an operator performs a predetermined operation by the input unit 22 to set the analysis condition of the SIM (selective ion monitoring) measurement and the voltage adjustment execution condition. The SIM measurement analysis condition is, for example, one or a plurality of mass-to-charge ratios (m/z values) to be subjected to the SIM measurement, temperatures of respective parts of the device, and the like.

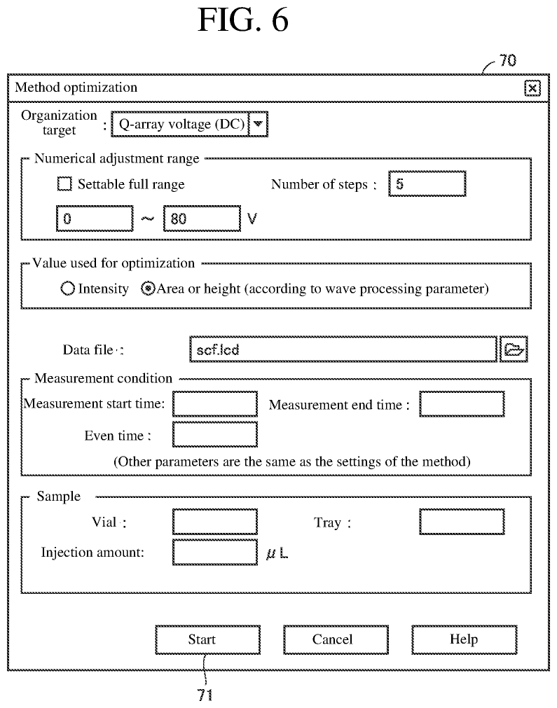

To set the voltage adjustment execution condition, an operator performs a predetermined operation by the input unit 22 to display the setting screen 70 shown in FIG. 6 on the display screen of the display 24. The operator sets the type of the target (ion-transportation optical system) to be voltage-optimized, the voltage value adjustment range and the number of voltage steps, and the type of data used to determine the optimum value, etc., by the input unit 22. In Example of FIG. 6, the optimization target is the DC voltage applied to the Q-array (first ion guide 44), the adjustment range of the voltage value is 0 [V] to 80 [V], the number of voltage steps is 5, and the height or the area of the chromatogram peak is used to calculate the optimum value.

After setting required conditions and parameters in the setting screen 70 of FIG. 6, when the operator clicks the “Start” button 71, the central control unit 64 starts the voltage adjustment operation for the voltage optimization in Step S02. First, in Step S03, based on the various conditions and parameters set in Step S0, an analysis method file for performing an analysis is generated. Next, in Step S04, the analysis control unit 62 performs the actual measurements according to the generated analysis method file.

Here, it is assumed that the DC voltage applied to the second ion guide 47 is changed by 10 [V] step in the range of 0 [V] to 50 [V]. It is also assumed that the m/z values of the SIM measurement target are three values of M1, M2, and M3.

In this instance, first, with respect to m/z=M1, V1 is changed in the order of V1=0, 10, 20, 30, 40, and 50 [V], and measurements are performed on the adjustment sample prepared in the adjustment sample introduction portion 35. Alternatively, it may be configured such that in a state in which the applied voltage is fixed at V1=0, a measurement is performed by changing m/z in the order of m/z=M1, M2, and M3, and after the completion of the measurement, the same measurement is repeated by changing to V1=10 [V]. In either case, the measurement of the same adjustment sample is performed for all of the combinations of the set m/z values and applied voltages.

The adjustment sample is introduced into the MS unit with the mobile phase from the adjustment sample introduction portion 35. The adjustment sample is a standard sample prepared by, e.g., manufacturers of analyzers AD and contains known levels of known ingredients. However, the adjustment sample may be an objective sample prepared by the user of the analyzer AD (usually, the sample with known ingredients).

During the adjustment sample measurement in Step S04, the data processing unit 60 collects the log for the internal operation of the analyzer AD (hereinafter may be referred to as “operation log”) in Step S05. The data processing unit 60 stores the collected operation log in the HDD 18 provided in the information processing apparatus 2 (see FIG. 3). In this specification, the “operation log” includes information indicating the operation command issued within (information processing apparatus 2) of the analyzer AD based on the analysis condition and/or the operating condition and information indicating the operation content actually performed by the analyzer AD (device body 1) in response to the operation command. The operation log stored in the HDD 40 can be used for the abnormality analysis in a case where an abnormality is detected during the execution of the automatic voltage adjustment as described below.

Based on the detection signal from the ion detector 51, the data processing unit 60 generates a chromatogram indicating the temporal change of the signal intensity at the target m/z value. Next, the data processing unit 60 detects the peak in the generated chromatogram and calculates, for example, the area of the peak. For each m/z value and each applied voltage, a chromatogram is generated to obtain the area value of the peak. In Step S06, the data processing unit 60 compares the area values obtained when the applied voltage is changed with respect to the same m/z value, and the applied voltage at which the area value becomes maximum can be determined as the optimum voltage value.

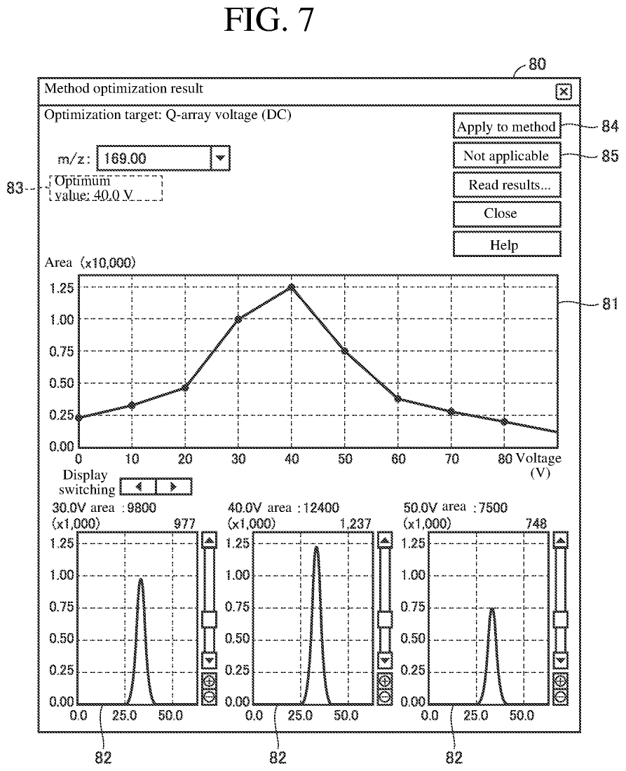

Next, in Step S07, the data processing unit 60 displays the optimization result screen 80 shown in FIG. 7 on the display screen of the display 24. The optimization result screen 80 includes a graph 81 indicating the relation between the signal strength and the applied voltage. The vertical axis of the graph 81 indicates the peak area value, and the horizontal axis indicates the voltage value. The optimization result screen 80 also includes a chromatogram 82 obtained for each voltage value. Further, it includes an automatically determined optimum voltage value 83 (40.0 V in Example of FIG. 7).

In Step S08, the operator confirms the shape of the graph 81 and the chromatogram 82 by the optimization result screen 80 of FIG. 7 to determine whether or not the optimum voltage value 83 is appropriate. In the example of FIG. 7, in the curve of the graph 81, the area value is spread in a hem-shape to the low-voltage side and the high-voltage side with the optimum voltage value 40 V as a peak. The shape of the waveform of the chromatogram 82 is undisturbed and relatively similar regardless of the voltage value. From the above, it can be determined that the optimum voltage value is appropriate. In a case where the optimum voltage value is appropriate (when it is determined as “YES” in S08), when the operator clicks on the “Apply to method” button 84 included in the optimization result screen 80, in Step S09, the central control unit 64 determines the optimum voltage value in accordance with the operation and reflects this in the analysis condition of the SIM measurement.

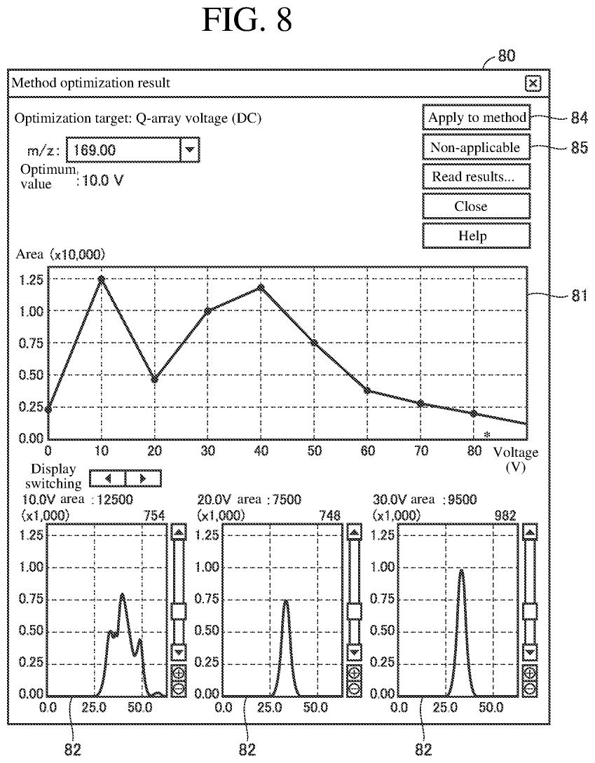

On the other hand, in a case where the optimum voltage value is inappropriate (when it is determined as “NO” in S08), the operator clicks on the “Not applicable” button 85 included in the optimization result screen 80. For example, as shown in FIG. 8, in the graph 81 shown in the optimization result screen 80, in a case where there exist two peaks, or in a case where the area value of the peak deviates greatly from the assumed value with respect to the standard sample, it is determined that the optimum voltage value is inappropriate. Alternatively, in a case where the waveform is distorted in at least one of the chromatograms 82 obtained for each voltage value, it is determined that the optimum voltage value is inappropriate. As described above, in a case where the optimum voltage value is inappropriate, it can be detected that there is a possibility that any abnormality has occurred inside the device body 1.

Note that it may be configured such that the determination whether or not the optimum voltage value in Step S08 is appropriate is performed by the information processing apparatus 2, instead of being performed by the operator. With this, it is possible to reduce the burden on the operator, and it is also possible to make an appropriate determination without being influenced by the experiences, skills, and the like, of the operator. The central control unit 64 automatically determines the optimum voltage value when it determines that the optimum voltage value is appropriate and reflects this in the analysis condition of the SIM-measurement. On the other hand, when the optimum voltage value is determined to be inappropriate, the central control unit 64 can inform the operator that the automatic voltage adjustment cannot be executed normally and that there is a possibility of an abnormality in the device body 1, using the display-screen of the display 24 or other notifying means.

When the optimum voltage value is inappropriate (when it is determined as “NO” in S08), in Step S10, the central control unit 64 transmits the operation log stored in the HDD 40 to the server 4 via the Internet 3 in receipt of the manipulation. More specifically, an operation log related to the current automatic voltage adjustment is extracted from operation logs stored in the HDD 40 and transmitted to the server 4.

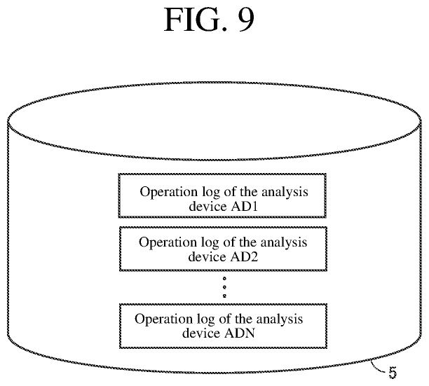

In receipt to the operation log transmitted from the information processing apparatus 2 of the analyzer AD through the Internet 3, in Step S21, the server 4 stores the received operation log in the database 5. FIG. 9 shows a configuration example of the database 5. Referring to FIG. 9, the database 5 stores the operation log of each of the N analyzers AD1 to ADN (see FIG. 1) communicatively connected to the server 4. The operation log is stored in one file for each analyzer AD. The operation log stored in each file indicates the internal operation of the analyzer AD when the abnormality is detected in the corresponding analyzer AD.

In the management center managing the analysis system 100 (e.g., a support center operated by a device manufacturer or the like of the analyzer AD), the operation log corresponding to the analyzer AD in which the abnormality is detected is read from the database 5, and the abnormality of the analyzer AD can be analyzed using the read operation log.

As described above, the operation log includes an operation command issued by the information processing apparatus 2 and the information indicating the operation content actually performed by the device body 1 in response to the operation command. Therefore, by comparing the operation command with the actual operation content, it is possible to detect the erroneous operation contrary to the operation command. Then, it is possible to identify the failure point that caused the malfunction, the failure content of the failure point, the cause of the failure, etc., from the content of the detected malfunction.

Returning to FIG. 5, in Step S22, when an abnormality analysis of the analyzer AD is performed using the operation log, the processing proceeds to Step S23 and the server 4 transmits the result of the abnormality analysis to the information processing apparatus 2 of the analyzer AD via the Internet 3. In receipt of the abnormality analysis transmitted from the server 4 in Step S11, the information processing apparatus 2 displays the received abnormality analysis in the display windows of the display 24. The operator or the user of the analyzer AD can take measures, such as, e.g., requesting the repair of the failed part or the replacement of the parts, based on the abnormality analysis result. The server 4 corresponds to one example of the “analysis unit”.

Note that in the above-described embodiment, the configuration in which the abnormality analysis is performed using the operation log stored in the database 5 has been made, but it may be configured such that the operation log stored in the HDD 18 of the information processing apparatus 2 is read and the abnormality analysis is performed.

### <Operation Log>

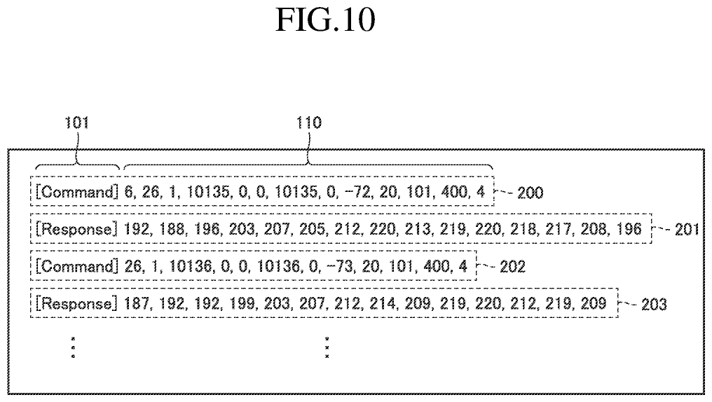

Next, a configuration example of an operation log will be described with reference to FIG. 10 to FIG. 12.

### Configuration Example 1

FIG. 10 shows a first configuration example of an operation log. Referring to FIG. 10, in the first configuration example, the operation log has a form of a text file. The operation log contains an operation command (Command) issued by the information processing apparatus 2 and an operation content (Response) actually performed by the device body 1 in response to this operation command. In the example of FIG. 10, the character strings 200 and 202 indicating the operation command and the character strings 201 and 203 indicating the operation content are shown.

These character strings are arranged in the time sequence. The character strings 200 to 203 have message parts 110 represented by a plurality of codes. In the example of FIG. 10, each of the plurality of codes is composed of several digits. In the character string 200, 202 showing the operation command, each code represents the information about the output destination of the operation command, the content of the operation code, and so on. In the character string 201, 203 indicating the operation content, each code indicates the information about the content of the operation, etc.

In the case of the above-described voltage adjustment operation, the character string 200, 202 indicating the operation command includes the analysis condition and the voltage adjustment execution condition of the SIM measurement (e.g., the information indicating the adjustment range and the number of the voltage step of the voltage value). The character string 201, 203 indicating the operation content includes the actual applied voltage and the detection signal of the ion detector 51. The character string 201, 203 further includes a chromatogram obtained for each voltage value.

As shown in FIG. 10, in the operation log, the character string 200 indicating the operation command and the character string 201 indicating the operation content responded to the operation command are associated in a one-to-one relation. Further, the character string 202 indicating the operation command and the character string 204 indicating the operation content responded to the operation command are associated in a one-to-one relation. As described above, by storing the character string indicating the operation command and the character string indicating the operation content responded to the operation command as a set, the person in charge of the abnormality analysis can easily compare the operation command with the actual operation content. This facilitates the detection of the erroneous operation against the operation command. As a result, the abnormality analysis can be performed efficiently.

At the first part of the character string 200, 202 indicating the operation command, a tag 101 of [Command] is given. At the first part of the character string 201, 203 indicating the operation, a tag 101 of [Response] is given. By giving the 101 to each character string, it is possible to easily distinguish between the information indicating the operation command and the information indicating the operation content.

### Configuration Example 2

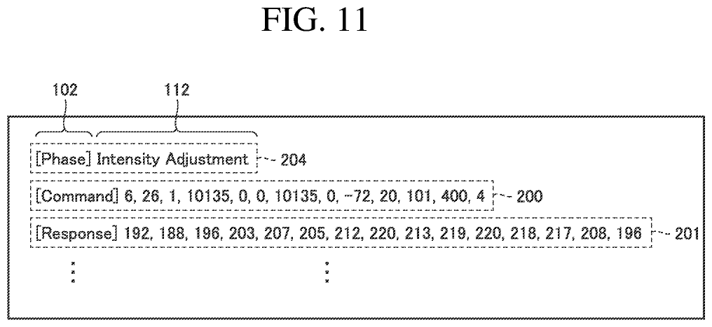

FIG. 11 is a diagram showing a second configuration example of an operation log. Referring to FIG. 11, the second configuration example is obtained by adding a character string 204 indicating the operation purpose of the analyzer AD (device body 1), as compared with the first configuration example shown in FIG. 7.

In the automatic adjustment function of the analyzer AD, in addition to the voltage adjustment operation described above, a sensitivity adjustment and a resolution adjustment of each part are performed in order according to a predetermined procedure. Therefore, it is required to clarify which stage (phase) of the automatic adjustment function is being executed in the operation log. In the embodiment of FIG. 8, the character string 204 has a message part 112 indicating the phase of the automatic adjustment. This clarifies that the analyzer AD has been operation for what kind object of the adjustment analyzer.

Further, at the first part of the character string 204, a tag 102 of [Phase] is given. By giving the tag 102, the person in charge of the abnormality analysis can easily recognize that the character string indicates the phase.

### Configuration Example 3

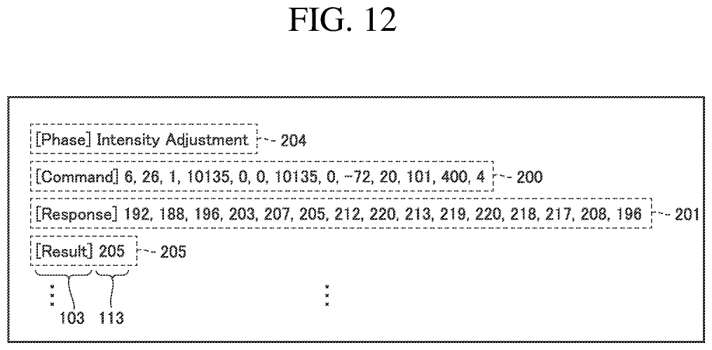

FIG. 12 is a diagram showing a third configuration example of an operation log. Referring to FIG. 12, in the third configuration example, as compared with the second configuration example, a character string 205 indicating the result (Result) derived by the information processing apparatus 2 based on the operation of the device body 1 is further given.

In the case of the voltage adjustment operation described above, the character string 205 includes the information indicating the optimum voltage value set by the data processing unit 60. Although not shown, the character string 205 may include the information indicating various parameters set for each adjustment phase. According to this, since the operation responded to the operation command and the parameter set based on this operation are shown in an associated manner, the person in charge of the abnormality analysis can perform the abnormality analysis more efficiently.

Further, a tag 103 of [Result] is given to the first part of the character string 205. By giving the tag 103, the person in charge of the analysis can easily recognize that the character string indicates the result.

### Example of Operation Log Usage

In the above-described embodiment, a configuration in which an operation log is used for an abnormality analysis of an analyzer AD has been described, but the operation log can be utilized for an abnormality sign diagnostic of an analyzer AD, an analysis accuracy assurance of an analyzer AD, and the like, as described below.

### (1) Abnormality Sign Diagnostic

In the abnormality sign diagnostic of the analyzer AD, the presence or absence of the abnormality sign of the analyzer AD is diagnosed by using an operation log collected at the time of the automatic adjustment. In this embodiment, it is assumed that the operation log collected when the analyzer AD is operating normally is stored as the reference operation log and that the presence or absence of the sign of the abnormal state of the analyzer AD is diagnosed based on the newly collected operation log and the reference operation log.

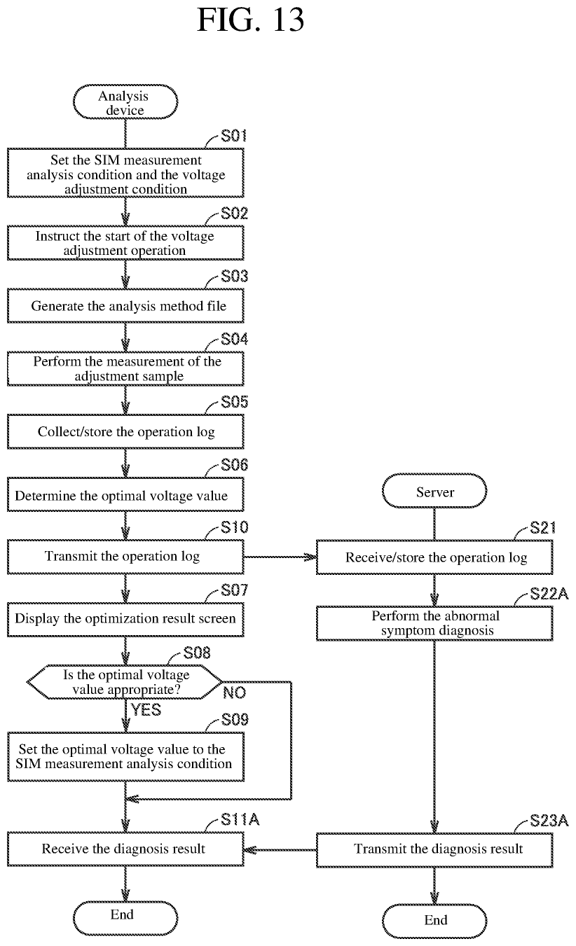

FIG. 13 is a flowchart for explaining the processing procedures for performing the automatic voltage adjustment and the abnormality sign diagnostics. The flowchart shown in FIG. 13 differs from the flowchart shown in FIG. 5 in the timing of the processing (Step S10) and in that the server 4 performs the normality sign diagnostic processing (Step S22A).

Specifically, referring to FIG. 13, the analyzer AD executes the voltage adjustment operation by executing the processing of Steps S01 to S06, which are the same as those of FIG. 5, collects the operation log during the voltage adjustment operation, and stores the collected operation log in the HDD 18 in the information processing apparatus 2, which is shown in FIG. 3.

When the analyzer AD determines the optimum voltage value in Step S06, the process proceeds to Step S10, where the analyzer AD transmits the operation log stored in the HDD 18 to the server 4 via the Internet 3. More specifically, an operation log related to the current automatic voltage adjustment is extracted from the operation logs stored in the HDD 18 and transmitted to the server 4.

In the flowchart of FIG. 13, each time the voltage adjustment operation is executed, the operation log at that time is transmitted to the server 4. With this, in a case where an automatic voltage adjustment is periodically executed, for example, once a month, the operation log is also periodically transmitted to the server 4.

In the server 4, in Step S21, when the operation log transmitted from the information processing apparatus 2 of the analyzer AD through the Internet 3 is received, the received operation log is stored in the database 5 (FIG. 9).

In Step S22A, in the management center that manages the analysis system 100, the operation log corresponding to the analyzer AD can be read from the database 5, and the abnormality sign diagnostic of the analyzer AD can be executed using the read operation log. Specifically, the analysis compares the content of the operation (Response) performed in response to the same operation command (Command) between the reference operation log previously stored in the database 5 and the newly acquired operation log. In a case where the operation content coincides between these two operation logs, it can be diagnosed such that there is no abnormality sign.

On the other hand, in a case where the operation contents do not coincide, it can be diagnosed that there is an abnormality sign. For example, chromatogram shapes obtained for a voltage value are compared between the reference operation log and the current operation log. In a case where a disturbance of chromatogram waveforms, which is not seen in the reference operation log, appears in this operation log, it can be diagnosed that there is an abnormality sign.

Abnormalities occurring in the analyzer AD may occur mainly due to the deterioration caused by factors, such as, e.g., adherence of a sample to the surface of each part due to repeated usages of the analyzer AD, oxidization of the surface, and deviation of the physical arrangement. The abnormalities can be detected early at the stage of signs by performing the above-described abnormality sign diagnostic. In Step S23A, the server 4 notifies the user of the analyzer A/D that the abnormality sign has been detected, thereby making it possible to recommend the replacement of a deteriorated component or the like. As a result, it is possible to prevent the occurrence of abnormalities in the analyzer AD. The server 4 corresponds to one example of the Diagnostics Department.

Note that, in the embodiment described above, a configuration has been described in which the presence or absence of the abnormality sign is diagnosed based on the result of comparing the reference operation log stored in advance for one analyzer AD with the newly collected operation log, but the presence or absence of the abnormality sign can be diagnosed by comparing the plurality of operation logs collected in each of the plurality of analyzers AD communicatively connected to the server 4.

### (2) Analysis Accuracy Assurance

In the analysis accuracy assurance of the analyzer AD, calibration is performed to ensure the analysis accuracy of the analyzer AD, using the operation log collected during the automatic adjustment.

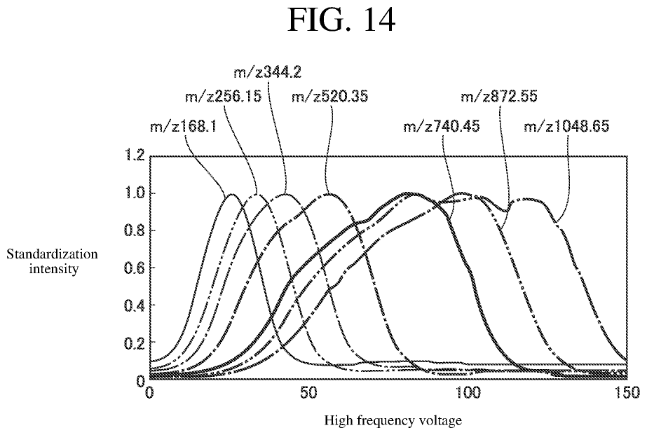

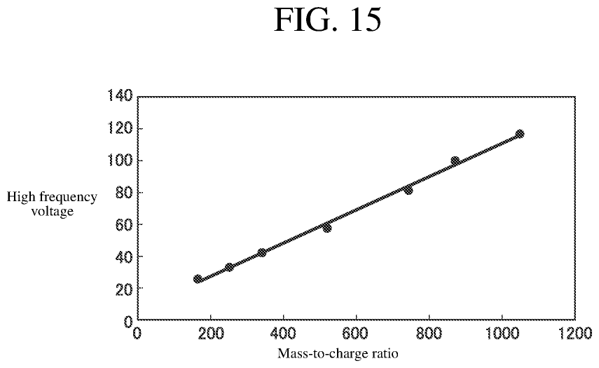

FIG. 14 is a diagram showing the actual measurement result in which the relation between the voltage value of the high-frequency voltage applied to the first ion guide 44 (see FIG. 2) and the signal intensity (here, the standardized ion intensity) detected by the ion detector 51 is actually measured in a plurality of mass-to-charge ratios. FIG. 15 is a diagram showing the relation between the mass-to-charge ratio and the optimum voltage value (the voltage value giving the largest ion intensity) obtained based on the actual measurement result of FIG. 14.

Referring to FIG. 14, the change in the signal intensity with respect to the change in the voltage value of the high-frequency voltage shows a generally peaked peak, but it can be seen that the higher the mass-to-charge ratio, the higher the optimum voltage value, and that the wider the peak becomes.

Further, it can be understood from the result of FIG. 15 that the mass-to-charge ratio and the optimum voltage value have a proportional relation. In FIG. 15, the relation between the mass-to-charge ratio and the optimum voltage value is approximated by a straight line. The relational expression representing the straight line shown in FIG. 15 can be initially calculated by the equipment manufacturer of the analyzer AD based on the actual measurement. Instead of the data indicating the relational expression, the table indicating the relation between the mass-to-charge ratio and the optimum voltage value may be generated.

However, in a case where an analyzer AD is disassembled and reassembled in order to remove the contamination of the first ion guide 44, or in a case where the first ion guide 44 is replaced with a new one, the arrangement, etc., of the electrode plates is slightly changed. Therefore, there is a possibility that the above-described relational expression changes. For such a case, the processing for newly obtaining the above-described relational expression is periodically executed. This processing uses the operation log collected at the time of the automatic adjustment.

Specifically, each time the voltage value of the high-frequency voltage applied to the first ion guide 44 changes, the data processing unit 60 acquires the signal strength data in a plurality of mass-to-charge ratios and calculates the voltage value at which the signal strength becomes maximum based on the acquired signal strength data. The data processing unit 60 collects the relation between the mass-to-charge ratio and the optimum voltage value obtained based on the actual measurement result as an operation log and stores it in the HDD 18. The information processing apparatus 2 transmits the operation log stored in the HDD 18 to the server 4 through the Internet 3.

In receipt of the operation log transmitted from the information processing apparatus 2 of the analyzer AD through the Internet 3, the server 4 stores the received operation log in the database 5 (FIG. 9). In the management center that manages the analysis system 100, the operation log corresponding to the analyzer AD is read from the database 5 and calculates the relational expression using the read operation log.

In calculating the relational expression, the server 4 determines whether or not the mass-to-charge ratio included in the operation log and the optimum voltage value have a proportional relation. In some cases, the plurality of measurement points representing the relation between the mass-to-charge ratio and the optimum voltage value includes a measurement point significantly deviated from the straight line shown in FIG. 15. The cause is considered that the peak shape of the signal intensity shown in FIG. 14 was collapsed from the mountain shape, which resulted in incorrect detection of the optimum voltage value. When such a measurement point is used, there is a concern that a correct relational expression cannot be obtained.

Therefore, in the server 4, the relational expression is calculated by excluding the inappropriate measurement points from the plurality of measurement points obtained from the operation log. In this manner, the correct relational expression can be obtained, so that the analysis accuracy of the analyzer AD can be guaranteed.

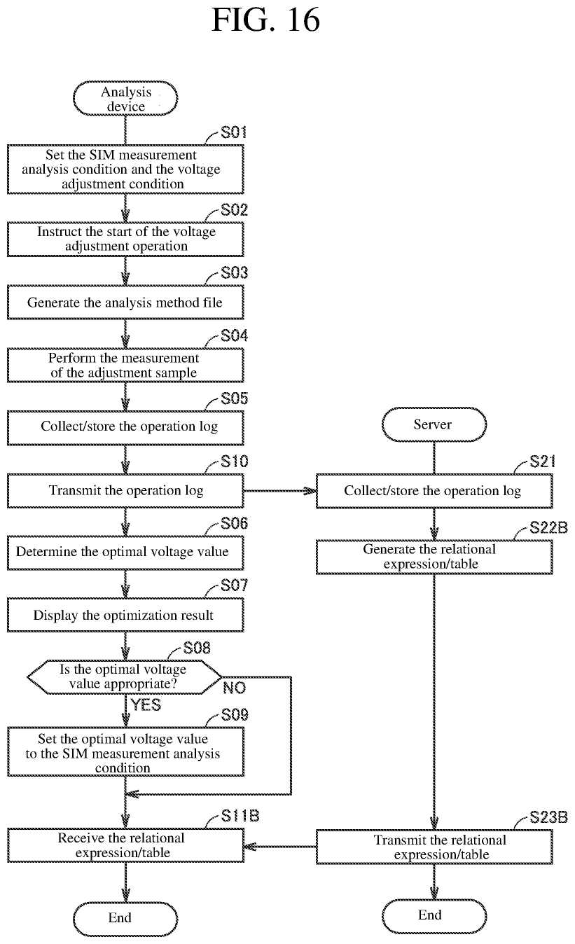

FIG. 16 is a flowchart for explaining the processing procedures when performing the automatic voltage adjustment and the analyzer calibration. The flowchart shown in FIG. 16 differs from the flowchart shown in FIG. 5 in the timing of the processing of transmitting the operation log (Step S10) and in that the server 4 performs the processing of generating the relational expression (or table) of the analyzer AD (Step S22B).

Specifically, referring to FIG. 16, the analyzer AD executes the voltage adjustment operation by executing the same processing of Steps S01 to S06 as those of FIG. 5, collects the operation log during the voltage adjustment operation, and stores the collected operation log in the HDD 18 in the information processing apparatus 2 (see FIG. 3).

When the analyzer AD collects the operation log in Step S05, the process proceeds to Step S10 to transmit the operation log stored in the HDD 18 to the server 4 via the Internet 3.

In the flowchart of FIG. 16, in Step S22B, the calibration of the analyzer AD is executed using the operation log transmitted every time the voltage adjustment operation is executed. Specifically, in receipt of the operation log transmitted from the information processing apparatus 2 of the analyzer AD via the Internet 3 in Step S21, the server 4 stores the received operation log in the database 5 (FIG. 9).

In Step S22B, the server 4 reads the operation log corresponding to the analyzer AD from the database 5 and generates a relational expression or a table indicating the relation between the mass-to-charge ratio and the optimum voltage value using the read operation log. At this time, the server 4 calculates a relational expression or a table by excluding an inappropriate measurement point from a plurality of measurement points obtained from the operation log. The server 4 transmits the relational expression or the table generated in Step S23B to the analyzer AD. Upon receipt of the relational expression or the table in Step S11B, the analyzer AD stores the relational expression or the table in the HDD 18.

Note that, in this embodiment, a liquid chromatograph mass spectrometer is exemplified as a analyzer, but even in a case where an analyzer is other than a liquid chromatograph mass spectrometer, an analyzer which is a device for analyzing a sample and has a function of transferring data to and from the server can be applied.

While an embodiment of the present disclosure has been described, it is to be considered that an embodiment disclosed herein is illustrative and not restrictive in all respects. The scope of the present invention is indicated by claims, and it is intended to include all modifications within the meanings and ranges equivalent to those of the claims.

1. An analyzer comprising:
a device body configured to analyze a sample; and
an information processing apparatus configured to control an operation of the device body,
wherein the information processing apparatus is configured to collect an operation log indicating an internal operation of the device body, and
wherein in the operation log, information indicating an operation command issued by the information processing apparatus based on an analysis condition and/or an operating condition and information indicating an operation content executed by the device body in response to the operation command are associated on a one-to-one basis.

2. The analyzer as recited in claim 1,
wherein in the operation log, the information indicating the operation command is given by a tag indicating that the information relates to the operation command, and the information indicating the operation content is given by a tag indicating that the information relates to the operation content.

3. The analyzer as recited in claim 1,
wherein the operation log further includes information indicating an object of an operation of the device body.

4. The analyzer as recited in claim 1,
wherein the operation log further includes information indicating a result derived by the information processing apparatus based on the operation of the device body.

5. An analysis system comprising:
the analyzer as recited in claim 1; and
a server communicatively coupled with the analyzer,
wherein the analyzer is configured to transmit the collected operation log to the server, and
wherein the server includes a storage unit for storing the operation log.

6. The analysis system as recited in claim 5,
wherein the analyzer is configured to transmit the operation log to the server when an abnormality of the analyzer is detected, and
wherein an abnormality analysis of the analyzer is performed using the operation log stored in the storage unit.

7. The analysis system as recited in claim 5,
wherein the analyzer is configured to periodically transmit the operation log to the server, and
wherein the presence or absence of an abnormality sign of the analyzer is diagnosed using the operation log stored in the storage unit.

8. The analysis system as recited in claim 5,
wherein the analyzer is configured to periodically transmit the operation log to the server, and
wherein calibration to ensure analysis accuracy of the analyzer is performed using the operation log stored in the storage unit.

9. An analysis system comprising:
an analyzer; and
an analysis unit configured to perform an abnormality analysis of the analyzer,
wherein the analyzer includes:
a device body configured to analyze a sample; and
an information processing apparatus configured to control an operation of the device body,
wherein the information processing apparatus is configured to collect an operation log indicating an internal operation of the device body,
wherein in the operation log, information indicating an operation command issued by the information processing apparatus based on an analysis condition and/or an operating condition and information indicating an operation content performed by the device body in response to the operation command are associated on a one-to-one basis, and
wherein the analysis unit performs an abnormality analysis of the analyzer based on the operation log when an abnormality of the analyzer is detected.

10. An analysis system comprising:
an analyzer; and
a diagnostic unit configured to diagnose an abnormality sign of the analyzer,
wherein the analyzer includes:
a device body configured to analyze a sample; and
an information processing apparatus configured to control an operation of the device body,
wherein the information processing apparatus is configured to collect an operation log indicating an internal operation of the device body,
wherein in the operation log, information indicating an operation command issued by the information processing apparatus based on an analysis condition and/or an operating condition and information indicating an operation content performed by a device body in response to the operation command are associated on a one-to-one basis, and
wherein the diagnosing unit diagnoses the presence or absence of an abnormality sign of the analyzer based on the operation log.
